(19) United States
(12) Patent Application Publication
(10) Pub. No.: US 2005/0268472 A1
(43) Pub. Date: Dec. 8, 2005

(54) Shaving systems

(76) Inventors: Jordan T. Bourilkov, Stamford, CT (US); George Cintra, Holliston, MA (US); Stuart M. Davis, Norfolk, MA (US); Andrew G. Gilicinski, Westborough, MA (US); Gordon G. Guay, Chelmsford, MA (US); Andrew Szczepanowski, Walpole, MA (US); Robert A. Trotta, Pembroke, MA (US)

Correspondence Address: FISH & RICHARDSON PC, P.O. BOX 1022, MINNEAPOLIS, MN, 55440-1022, US

(21) Appl. No.: 10/863,027

(22) Filed: Jun. 7, 2004

(51) Int. Cl. B26B 21/40

(52) U.S. Cl. 30/537

(57) ABSTRACT

Shaving systems and related methods are disclosed. In some embodiments, a shaving system includes a first electrical power source, a razor, and a second electrical power source in the razor, wherein the first electrical power source is capable of charging the second electrical power source.

### TECHNICAL FIELD

The invention relates to shaving systems.

### BACKGROUND

Shaving systems include dry shaving razors and wet shaving razors. An example of a dry shaving razor is an electric razor, which can be used without water, soap, or shaving cream. Wet shaving razors are typically used with water and soap or shaving cream. A wet shaving razor can include a handle and a replaceable cartridge in which one or more blades are mounted in a housing. After the blades in a cartridge have become dull from use, the cartridge is discarded, and a new cartridge is replaced on the handle.

One type of wet shaving razor is an oscillating or vibrating wet shaving razor. The razor includes a power source (such as a battery) and a motor capable of oscillating or vibrating the blade(s) of the razor. Vibrations at the surface of the razor blade can massage the skin, isolate the facial nerves from the discomforts of shaving, and assist the cartridge in floating over the skin so that the blades can slide more easily over the skin. Oscillating razors are described, for example, in Metcalf et al., U.S. Pat. No. 5,299,354, hereby incorporated by reference.

### SUMMARY

In one aspect, the invention features a shaving system having a first electrical power source, a razor, and a second electrical power source in the razor, wherein the first electrical power source is capable of charging the second electrical power source. For example, the shaving system can be a wet shaving system, the first electrical power source can be one or more primary batteries, and the second electrical power source can be one or more secondary, or rechargeable, batteries.

Charging the second electrical power source with another power source in the shaving system enhances the portability of the shaving system. The shaving system need not rely on “mains” power, e.g., electrical power from an electrical outlet, to function. A depleted battery in the razor can be recharged virtually anywhere without additional components.

In preferred embodiments, the first electrical power source is integrated in a razor cartridge dispenser of the shaving system. As a result, replacement of the first electrical power source can be a transparent process to the user. When the dispenser is depleted of cartridges, the user can refill the shaving system with new cartridges and a new first electrical power source in one seamless step, thereby enhancing the simplicity of use and consumer friendliness of the shaving system.

In some embodiments, the shaving system can be adapted to interface with a mains power source. Alternatively or additionally, the first electrical power source can charge the second electrical power source without contacting the first electrical power source, e.g., by inductive charging.

In another aspect, the invention features a shaving system, including a first battery, a razor, and a second battery in the razor, wherein the first battery is capable of charging the second battery.

In another aspect, the invention features a shaving system, including a base comprising a first battery associated with the base, a razor capable of mating with the base, and a second battery in the razor, wherein the first battery is capable of charging the second battery when the razor is mated with the base.

In another aspect, the invention features a shaving system, including a base, a razor capable of mating with the base, the razor including a handle capable of engaging with a cartridge having a blade, a secondary battery carried by the razor, and a dispenser capable of mating with the base, the dispenser including one or more razor cartridges, and a primary battery capable of charging the secondary battery.

In another aspect, the invention features a wet shaving system, including a first electrical power source, a razor, and a second electrical power source in the razor, wherein the first electrical power source is capable of charging the second electrical power source.

Embodiments of the above aspects of the invention may include one or more of the following features.

The first battery can be a primary battery, such as an alkaline battery, a metal-air battery, a lithium battery, metal oxyhydroxide battery, a fuel cell, or a photovoltaic cell. The first battery can have a nominal open cell voltage greater than about 1.5 volt. The first battery can be prismatic. The first battery can be carried by the dispenser. The first battery can be capable of contacting the second battery through an electrical contact. The first battery can be capable of electrically contacting the second battery through a hook and loop fastener. The first battery can be capable of charging the second battery without contacting the second battery, for example, by inductively charging the second battery.

The second battery can be a secondary battery, such as, for example, a nickel-cadmium battery, a lithium ion battery, or a nickel metal hydride battery. The second battery can have a nominal open cell voltage from about 1.2 to about 2.4 volts.

The razor can include a handle and a cartridge having a blade, and the second battery can be in the handle. The razor can be electrically powered, for example, can be capable of vibrating.

The shaving system can further include a base configured to mate with the razor. The shaving system can further include a dispenser configured to mate with the base, the dispenser can be capable of carrying one or more razor cartridges. The shaving system can be configured to interface with a mains power source to charge the second battery.

In another aspect, the invention features a method, including providing a shaving system comprising a first battery, a razor carrying a second battery; and charging the second battery with the first battery.

Embodiments may include one or more of the following features. The second battery can be charged without contacting the second battery with the first battery, for example, charged inductively. The method can include contacting the second battery with the first battery through an electrical contact. The electrical contact can include a hook and loop fastener. The method can further include simultaneously adding one or more cartridges to the shaving system, and replacing the first battery with a third battery. The method can further include charging the second battery with a mains power source. The razor can be electrically powered. The method can further include vibrating the razor. The second battery can be a secondary battery, and the first battery can be a primary battery. The second battery can have a nominal open cell voltage from about 1.2 to about 2.4 volts, and the first battery can have a nominal open cell voltage greater than about 1.5 volt.

In another aspect, the invention features a method, including providing a shaving system including a first battery, a razor carrying a second battery; and simultaneously adding one or more cartridges to the shaving system, and replacing the first battery with a third battery. One or more cartridges can be added and the first battery is replaced by engaging a dispenser with a base capable of mating with the razor. The second battery can be a secondary battery, and the first battery and the third battery can be primary batteries. The third battery can be capable of charging the second battery. The method can further include charging the second battery with a mains power source.

In another aspect, the invention features a dispenser, including an electrical power source and at least one razor cartridge. The dispenser can include a plurality of razor cartridges. The electrical power source can be a battery, such as one or more primary batteries. The dispenser can be configured to be associated with a shaving system, for example, configured to mate with a base of the shaving system.

Other aspects, features and advantages of the invention will be apparent from the description of the preferred embodiments thereof and from the claims.

### DESCRIPTION OF DRAWINGS

FIG. 1 is an exploded illustration of an embodiment of a shaving system.

FIG. 2A is a perspective view of a portion of an embodiment of a shaving system; and

FIG. 2B is a bottom view of a base of FIG. 2A.

FIG. 3A is a perspective view of a portion of an embodiment of a shaving system; and

FIG. 3B is a bottom view of a base of FIG. 3A.

FIG. 4A is a perspective view of a portion of an embodiment of a shaving system; and

FIG. 4B is a bottom view of a base of FIG. 4A.

FIG. 5 is a schematic diagram of an embodiment of a shaving system adapted for contact charging from a high voltage primary battery.

FIG. 6 is a top view of an embodiment of a dispenser.

FIG. 7 is a schematic diagram of an embodiment of a shaving system adapted for inductive charging.

FIG. 8 is a schematic diagram of an embodiment of a shaving system adapted for interfacing with a mains power source.

FIG. 9 is a schematic diagram of an embodiment of a shaving system adapted for contact charging from a mains power source or a battery power source.

### DETAILED DESCRIPTION

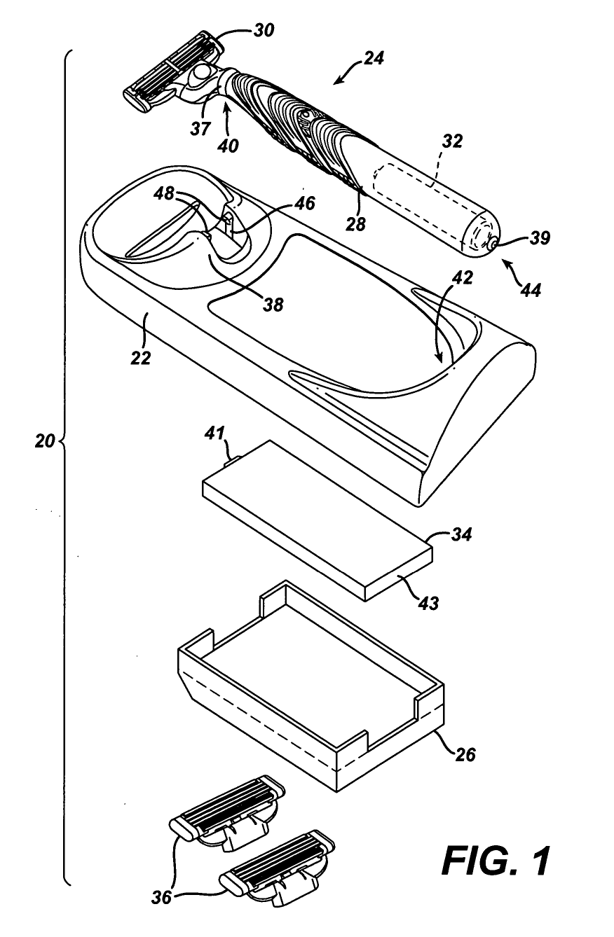

Referring to FIG. 1, a shaving system 20 includes a base or tray 22, a powered wet shaving razor 24 capable of being received by (e.g., mating with) the base, and a refill dispenser 26 capable of being received by (e.g., mating with) the base. Dispenser 26 includes a first battery 34 (such as a primary battery) integrated into the dispenser, and one or more replacement razor cartridges 36. As shown, razor 24 includes an elongated handle 28, a replaceable cartridge 30 carried at the distal end of the handle, and a second battery 32 (such as a secondary battery) carried within the handle. Powered by second battery 32, razor 24 can be, for example, of the vibrating type. In particular, when razor 24 and dispenser 26 are mated to base 22, first battery 34 is capable of charging (e.g., recharging) second battery 32 in the razor.

Charging a battery housed in razor 24 with another battery integrated in shaving system 20 enhances the portability of the shaving system. Shaving system 20 need not be dependent on or rely on “mains” power, e.g., electrical power from an electrical outlet, to function. A depleted battery in the razor can be recharged virtually anywhere. Furthermore, whereas certain appliances configured for sale in one region (e.g., the standard 110 Volts mains power in the United States) may require additional equipment, such as, a voltage converter or an outlet adapter, for use in another region (e.g., in Europe), shaving system 20 can be used without additional equipment. A depleted battery in razor 24 can be charged and recharged with another battery, which can be available worldwide under one standard.

Moreover, since first battery 34 is integrated into dispenser 26, replacement of the first battery is a transparent process to the user. In using shaving system 20, the user need not replace a depleted battery in a razor and replace a dispenser depleted of replacement cartridges in two distinct steps. Rather, in shaving system 20, the user refills the system with new cartridges and a new first battery in one seamless step. When dispenser 26 is depleted of cartridges and the user replaces the dispenser with a new dispenser, the user is also replacing first battery 34, thereby enhancing the simplicity of use and consumer friendliness of shaving system 20.

First battery 34 can charge second battery 32 by direct electrical contact when razor 24 and dispenser 26 (along with the first battery) are mated to base 22. First battery 34 includes a first contact 41 and a second contact 43. As shown in FIG. 1, razor 24 includes an external, distal electrical contact 37 (as shown, near a neck portion 40 of handle 28) and an external proximal contact 39 (as shown, at the proximal end 44 of the handle). Contacts 37 and 39 are electrically connected to the terminals of second battery 32 to enable first battery 34 to charge the second battery. As shown, distal contact 37 is an electrically conducting band (such as a metallic band), but in some embodiments, a U- or C-shaped member or two connected and opposing contacts can be used.

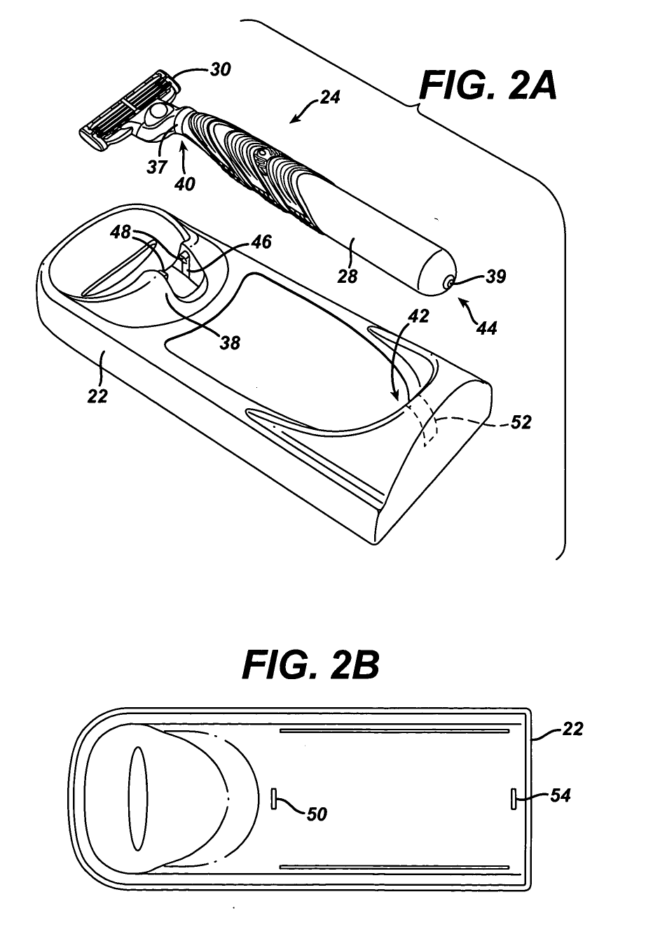

Base 22 is configured to electrically connect contacts 37 and 39 of razor 24 to contacts 41 and 43 of first battery 34, respectively. Referring to FIGS. 2A and 2B, on its top surface, base 22 includes a projecting structure 38 configured to receive neck portion 40 of handle 28, and a recessed portion 42 configured to receive proximal end 44 of the handle. Projecting structure 38 includes two resilient fingers 46, each having a first top electrical contact 48 that extends through base 22 and to the bottom surface of the base to form a first bottom electrical contact 50 (FIG. 2B). In recessed portion 42, base 22 includes a second top electrical contact 52 that extends through base 22 and to the bottom surface of the base to form a second bottom electrical contact 54.

Thus, when razor 24 and dispenser 26 are mated to base 22, first battery 34 is electrically connected to second battery 32 in the razor. More specifically, first contact 41 of first battery 34 contacts first bottom contact 50, which electrically connects to first top contact 48, which electrically connects to distal contact 37, which electrically connect to a first terminal of second battery 32. Second contact 43 of first battery 34 contacts second bottom contact 54, which electrically connects to second top contact 52, which electrically connects to proximal contact 39, which electrically connects to a second terminal of second battery 32. As a result, first battery 34 is capable of charging second battery 32.

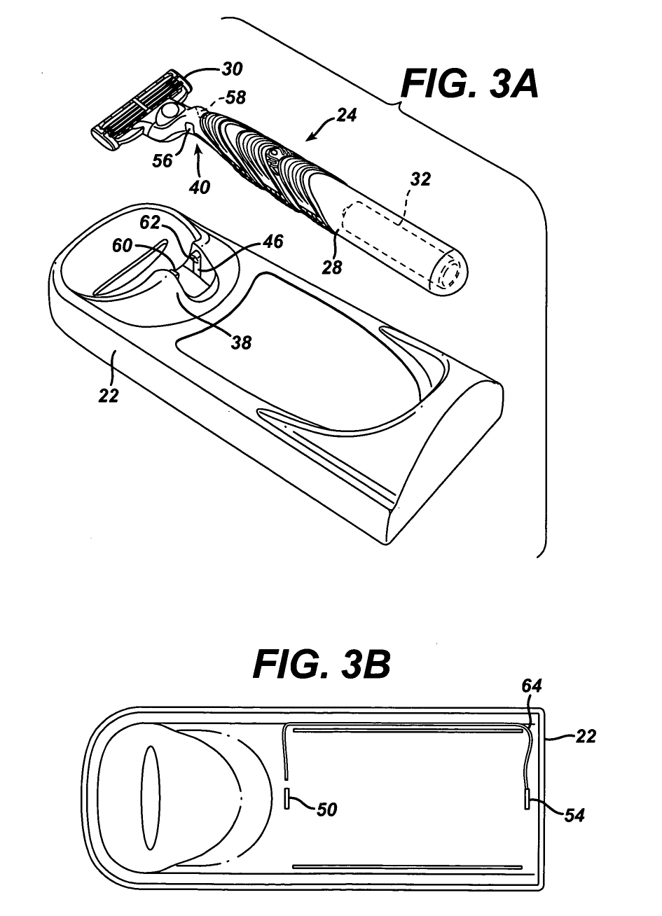

Other configurations of electrically connecting first battery 34 to second battery 32 can be used. For example, referring to FIGS. 3A and 3B, first battery 34 can electrically connect to second battery 32 through two separate and opposing contacts 56 and 58, both of which are near neck portion 40 of razor 24. Contact 56 is electrically connected to a first terminal of second battery 32, and contact 58 is electrically connected to a second terminal of the second battery. Resilient fingers 46 of base 22 include two separate contacts 60 and 62 configured to contact contacts 56 and 58, respectively. As shown, contact 62 extends through base 22 and to the bottom surface of the base to form first bottom electrical contact 50. Contact 60 extends through base 22 and to the bottom surface of the base where it is connected to second bottom contact 54, as shown, by a wire 64. Electrical connection between first battery 34 and second battery 32 is similar to that described above.

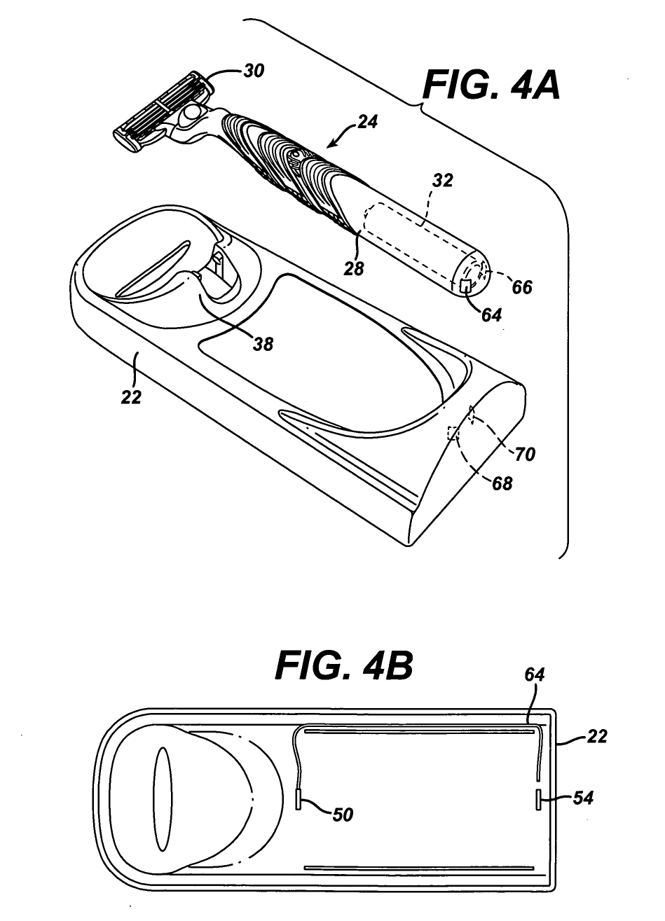

In other embodiments, referring to FIGS. 4A and 4B, first battery 34 can electrically connect to second battery 32 through two separate and opposing contacts 64 and 66, both of which are near proximal end 44 of razor 24. Contact 64 is electrically connected to a first terminal of second battery 32, and contact 66 is electrically connected to a second terminal of the second battery. Recessed portion 42 of base 22 includes two separate contacts 68 and 70 configured to contact contacts 64 and 66, respectively. As shown, contact 70 extends through base 22 and to the bottom surface of the base to form second bottom electrical contact 54. Contact 68 extends through base 22 and to the bottom surface of the base where it is connected to first bottom contact 50, as shown, by wire 64. Electrical connection between first battery 34 and second battery 32 is similar to that described above.

Still other embodiments can be used. For example, the electrical contacts on razor 24 can be formed anywhere between the distal and proximal ends of the razor. Base 22 can be configured to include corresponding contacts.

Referring again to FIG. 1, various embodiments of second battery 32 can also be used. Second battery 32 can be any source of electrical energy capable of providing power to operate razor 24. For example, second battery 32 may be able to power a motor in the razor for about five minutes. In some embodiments, second battery 32 has a nominal open cell voltage from about 1.2 volt to about 2.4 volts. Second battery 32 can be a secondary, or rechargeable, battery, such as a nickel-cadmium battery, a nickel metal hydride battery, a lithium ion battery, or a rechargeable alkaline battery. In certain embodiments, rechargeable batteries are capable of being used in powered shaving razors that require more power than certain primary alkaline batteries (such as AAA alkaline batteries) can supply. Second battery 32 can be nominally a primary battery. While razor 24 is shown as having one second battery, in other embodiments, the razor can include multiple (e.g., two, three or more) batteries, which can be connected in series or in parallel. Different types of second batteries can be used together in shaving system 20. Second battery 32 can be variously configured to fit in handle 28. For example, second battery 32 can be cylindrical (e.g., AA, AAA, or AAAA), or prismatic (e.g., as described in commonly assigned U.S. Ser. No. 09/692,869, filed Oct. 20, 2000).

First battery 34 can be any source of electrical energy capable of providing power to second battery 32. First battery 34 preferably has a low self discharge so as to keep its energy as long as possible. For example, first battery 34 may have a natural voltage potential capable of providing a trickle charge (such as a drain of about 50 mA over 10-12 hours) to second battery 32. For a razor having a single battery, for example, first battery 34 can have a nominal open cell voltage (such as from about 1.5 volt to about 1.6 volt) that allows good charging efficiency and current to flow from the first battery to second battery 32 without the need for control electronics. In embodiments in which razor 24 requires the energy of multiple cells in series, the voltage of the cells can be increased accordingly. The capacity of first battery 34 can be designed such that the first battery is substantially depleted as the last replacement cartridge 36 is used, e.g., 45 days for a dispenser having four replacement cartridges.

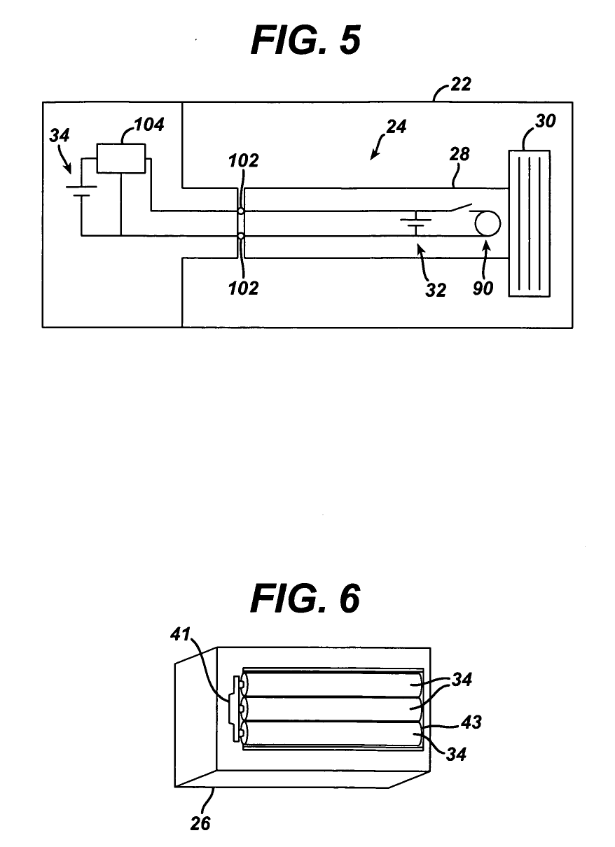

In some embodiments, such as when first battery 34 (e.g., a high power lithium battery) has a higher voltage than second battery 32, a charging circuit may be used to control the charging current and voltage to provide good charging of second battery 32. Referring to the schematic diagram of FIG. 5, a charging circuit 104 can be mounted on board base 22 (as shown), or associated with (e.g., integrated in) razor 24. Examples of charging circuits are described in Bourilkov et al., U.S. patent application Publication 2003/0155887-A1, entitled “Hybrid Power Supply”; and commonly assigned U.S. Ser. No. 10/382,106, entitled “Fuel Cell Hybrid Power Supply” and filed Mar. 5, 2003. Base 22 is electrically connected to razor 24 through contact with electrical contacts 102, e.g., spring-loaded contacts.

Similar to second battery 32, various embodiments of first battery 34 can also be used. First battery can be a primary battery, such as an alkaline battery (e.g., a manganese oxide-zinc battery), a metal-air battery, an air-assisted alkaline battery, a lithium battery, or a metal oxyhydroxide battery (e.g., a NiOOH-based battery). Other power sources, such as a fuel cell (e.g., an alcohol-based fuel cell described in U.S. Ser. No. 10/779,502, filed Feb. 13, 2004) or a photovoltaic cell, can be used as first battery. As shown above, dispenser 26 includes one first battery, but in other embodiments, referring to FIG. 6, the dispenser can include multiple (e.g., two, three, four or more) batteries, which can be connected in series or in parallel. Different types of first batteries can be used together in shaving system 20. First battery 34 can have various configurations, such as cylindrical (e.g., AA, AAA, or AAAA), prismatic (e.g., Duracell's LP1 (alkaline) prismatic battery or Duracell's CP1 (lithium) prismatic battery). First battery 34 can be a battery system having one or more batteries and an air manager system, e.g., as described in commonly assigned U.S. Ser. No. 10/236,106, filed Sep. 6, 2002, and U.S. Ser. No. 09/693,010, filed Oct. 20, 2000.

As used herein, primary batteries are meant to be discharged, e.g., to exhaustion, only once, and then discarded. Primary batteries are not intended to be recharged. Primary batteries are described, for example, in David Linden, Handbook of Batteries (McGraw-Hill, 2d ed. 1995). Secondary batteries can be recharged for many times, e.g., more than fifty times, more than a hundred times, or more. In some cases, secondary batteries can include relatively robust separators, such as those having many layers and/or that are relatively thick. Secondary batteries can also be designed to accommodate for changes, such as swelling, that can occur in the batteries. Secondary batteries are described, e.g., in Falk & Salkind, “Alkaline Storage Batteries”, John Wiley & Sons, Inc. 1969; U.S. Pat. No. 345,124; and French Patent No. 164,681, all hereby incorporated by reference.

Razor 24 can be any kind of electrically powered shaving razor, such as one that uses electrical power to perform one or more functions. For example, razor 24 can be a powered wet shaving razor of the vibrating or oscillating type, e.g., as described in U.S. Pat. Nos. 5,299,354, and exemplified by M3 Power shaving system, available from The Gillette Co. Razor 24 is configured to mate with base 22, e.g., by snap fitting between resilient fingers 46 and engaging with recessed portion 42.

As used herein, dispenser 26 is a carrier of an electrical power source and one or more razor cartridges 36. As described above, dispenser 26 is configured to carry replacement razor cartridge(s) 36 (e.g., by a snap fit) and one or more first batteries 34. Dispenser 26 can dispense cartridge(s) 26, for example, by engaging handle 28 to a cartridge, and/or by removing a cartridge by hand and connecting the cartridge on the handle. When dispenser 26 is mated to base 22 (e.g., by a snap fit), the terminals of first battery or batteries 34 are capable of electrically connecting to the terminals of second battery or batteries 32.

Base 22 serves as a docking station and an organizer for razor 24 and dispenser 26. Base 22 can be as described, for example, in Gray et al., U.S. Pat. 5,782, 346, modified with the contacts as described above.

In use, shaving system 20 can be used similarly to a conventional wet shaving system. Replacement cartridges 36 from dispenser 26 are placed on handle 28 after the blades in the cartridge on the handle become dull from use. When the last replacement cartridge 36 in dispenser 26 is used, shaving system 20 is refilled with a new dispenser, which simultaneously adds new cartridges and a new first battery 34 to the shaving system. The user may think he or she is only refilling the cartridges, but indeed he or she is also providing additional power to shaving system 20, thereby making battery replacement a transparent process.

While certain embodiments have been described, the invention is not so limited.

As an example, shaving system 20 can further include an indicator that indicates that proper electrical contact connections have been made and that charging is occurring. The indicator, such as a light, can be integrated on razor 24 and/or on base 22.

In some embodiments, the electrical contacts described above can include a conductive hook and loop fastener. Such fasteners are available, for example, from Velcro Corp. or Aplix Corp. The electrical contacts described above can have a variety of configurations, such as plug and socket fasteners, snap fasteners, or spring loaded pressure contacts.

In other embodiments, first battery 34 is capable of charging second battery 32 without contacting the second battery through an electrical contract. For example, second battery 32 can be charged through electromagnetic induction, in which no voltage match between the batteries is needed. Briefly, inductive charging can include a pair of electrical coils in close proximity of each other. A first coil is located on base 22 with first battery 34, and a second coil is located in razor 24 with second battery 32. When an electrical connection is made between batteries 32 and 34, current flows from the first battery through the first coil to produce a first magnetic field. Since the coils are in close proximity, the first magnetic field induces a voltage in the second coil. The induced voltage, in turn, produces a current that can power the razor. Inductive charging is described further in, for example, WO 95/11545, EP 314287, and WO 88/02944.

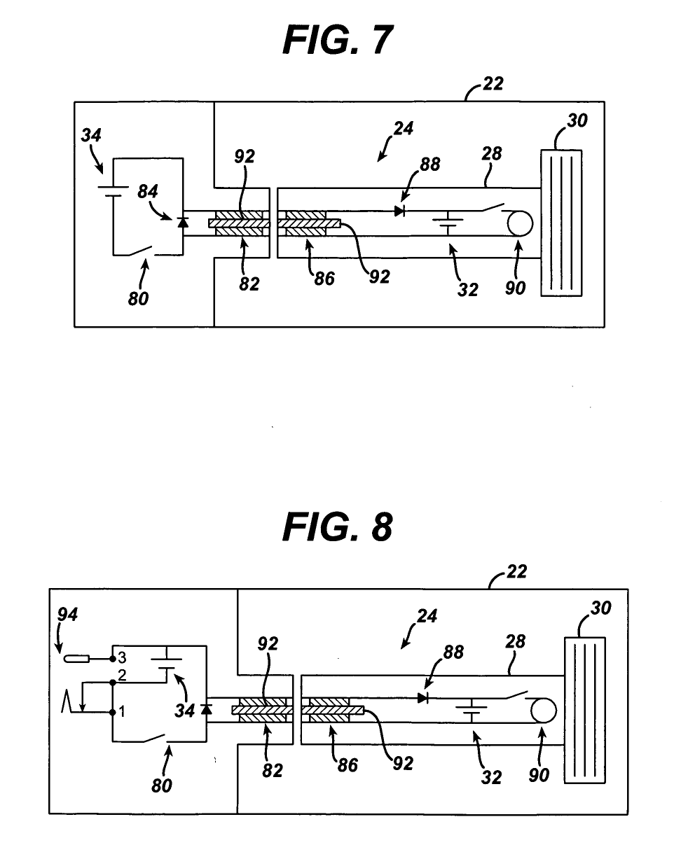

FIG. 7 shows a schematic diagram of a shaving system in which first battery 34 is adapted to inductively charge. In operation, first battery 34 in base 22 supplies electrical pulses to a first coil 82 via a switcher 80, which is controlled by a driving circuit, such as a pulse generator or oscillator. A catch diode 84 extends across coil 82. The electrical pulses produce a pulsed magnetic field that is transmitted to a second coil 86 in handle 28 of razor 24. Second coil 86, as shown, is coaxial with first coil 82. The inductively generated pulse voltage in receiving second coil 86 is rectified by a diode 88 and used to charge second battery 32, which is used to provide power to razor 24 (as shown, a motor 90 in the razor). The maximum voltage can be limited to a safe value by the coils windings ratio, such as 1.5V for a single rechargeable nickel-based cell, and the charging current could be limited so that not to exceed the “float” or trickle current of second battery, e.g. 1/50C for Ni-based cell, if 50% charge is sufficient per day. In some embodiments, either or both coils 82 and 86 include a ferrite core 92. Ferrite core 92 can have various shapes, such as cylindrical or toroidal.

Other methods of charging second battery 32 without contacting the second battery through an electrical contact include capacitive charging (e.g., by using adjacent surfaces) and/or optical charging (e.g., by using one or more photocouplers).

In other embodiments, shaving system 20 can be further configured to interface with a mains power source (such as an electrical outlet) to charge second battery 32. During use, when a mains power source is available, second battery 32 can be charged with mains power, thereby reserving the power of first battery 34. When a mains power source is unavailable, first battery 34 can charge second battery 32, as described above.

FIG. 8 shows a schematic diagram of a shaving system configured to interface with a mains power source to charge second battery 32. As shown, FIG. 8 includes features of FIG. 7. For the mains powered circuit, an AC/DC adapter 94 is plugged in base 22 using a DC power pack, which disconnects first battery 34 and provides DC power to second battery 32. In embodiments, the shaving system can also be adapted to charge a secondary battery in base 22 using the mains power source, and the secondary battery can be used to charge second battery 32 in razor 24.

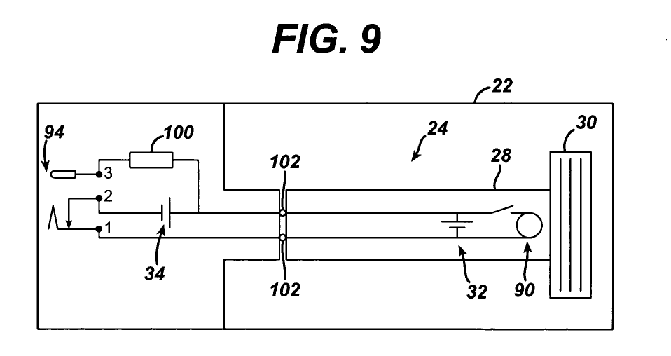

While the shaving system as shown in FIG. 8 is adapted for inductive charging, in other embodiments, the shaving system can be adapted to interface with a mains power source and to include direct electrical contact between base 22 and razor 24. Referring to FIG. 9, a charging current can be supplied from a battery (e.g., a primary battery) or from AC/DC adapter 94 through a current limiting resistor 100. When the power jack is not plugged in, the battery loop closes directly with the rechargeable battery. In some embodiments, a charging circuit, as described above, can be used in place of the current limiting resistor 100, for example, if voltage control is desirable with the chemistry of second battery 32. Base 22 is connected to razor 24 through contact with electrical contacts 102, e.g., spring-loaded contacts.

In certain embodiments, such as those in which the shaving system is adapted to interface with a mains power source, the shaving system includes one or more features that shield or block one or more electrical contacts when razor 24 is not mated to base 22. As a result, accidental contact by the user to a live mains power source can be prevented. Base 22 can include a narrow tubular member or a dome that surrounds second top electrical contact 52 of the base. The opening of the tubular member or the dome can be sized sufficiently large to allow razor 24 to touch contact 52 when the razor is mated to base 22, but small enough to prevent, for example, a finger to touch contact 52. Alternatively, base 22 can include one or more covers capable of shielding or blocking electrical contacts. The cover(s), such as a flap mounted on a hinge or a pivot, can be manually operated by the user or automatically operated, e.g., by spring forces.

All publications, applications, patents, and references referred to in this application are herein incorporated by reference in their entirety.

Other embodiments are within the claims.

1. A shaving system, comprising:
a first battery;
a razor; and
a second battery in the razor,
wherein the first battery is capable of charging the second battery.

2. The shaving system of claim 1, wherein the second battery is a secondary battery.

3. The shaving system of claim 2, wherein the secondary battery is selected from the group consisting of a nickel-cadmium battery, a lithium ion battery, and a nickel metal hydride battery.

4. The shaving system of claim 1, wherein the second battery has a nominal open cell voltage from about 1.2 to about 2.4 volts.

5. The shaving system of claim 1, wherein the razor comprises a handle and a cartridge comprising a blade, and the second battery is in the handle.

6. The shaving system of claim 1, wherein the razor is electrically powered.

7. The shaving system of claim 6, wherein the razor is capable of vibrating.

8. The shaving system of claim 1, wherein the first battery is a primary battery.

9. The shaving system of claim 8, wherein the primary battery is an electrical power source selected from the group consisting of an alkaline battery, a metal-air battery, a lithium battery, metal oxyhydroxide battery, a fuel cell, and a photovoltaic cell.

10. The shaving system of claim 1, wherein the first battery has a nominal open cell voltage greater than about 1.5 volt.

11. The shaving system of claim 1, wherein the first battery is prismatic.

12. The shaving system of claim 1, further comprising a base configured to mate with the razor.

13. The shaving system of claim 12, further comprising a dispenser configured to mate with the base, the dispenser capable of carrying one or more razor cartridges.

14. The shaving system of claim 13, wherein the first battery is carried by the dispenser.

15. The shaving system of claim 1, wherein the first battery is capable of contacting the second battery through an electrical contact.

16. The shaving system of claim 15, wherein the first battery is capable of electrically contacting the second battery through a hook and loop fastener.

17. The shaving system of claim 1, wherein the first battery is capable of charging the second battery without contacting the second battery.

18. The shaving system of claim 17, wherein the first battery is capable of inductively charging the second battery.

19. The shaving system of claim 1, wherein the shaving system is configured to interface with a mains power source to charge the second battery.

20. A shaving system, comprising:
a base comprising a first battery associated with the base;
a razor capable of mating with the base; and
a second battery in the razor,
wherein the first battery is capable of charging the second battery when the razor is mated with the base.

21. The shaving system of claim 20, wherein the second battery is a secondary battery.

22. The shaving system of claim 21, wherein the secondary battery is an electrical power source selected from the group consisting of a nickel-cadmium battery and a nickel metal hydride battery.

23. The shaving system of claim 20, wherein the second battery has a nominal open cell voltage from about 1.2 to about 2.4 volts.

24. The shaving system of claim 20, wherein the razor comprises a handle and a cartridge comprising a blade, and the second battery is in the handle.

25. The shaving system of claim 20, wherein the razor is electrically powered.

26. The shaving system of claim 20, wherein the razor is capable of vibrating.

27. The shaving system of claim 20, wherein the first battery is a primary battery.

28. The shaving system of claim 27 wherein the primary battery is an electrical power source selected from the group consisting of an alkaline battery, a metal-air battery, a lithium battery, metal oxyhydroxide battery, an air-assisted alkaline battery, a fuel cell, and a photovoltaic cell.

29. The shaving system of claim 20, wherein the first battery has a nominal open cell voltage greater than about 1.5 volt.

30. The shaving system of claim 20, wherein the first battery is prismatic.

31. The shaving system of claim 20, further comprising a dispenser configured to mate with the base, the dispenser capable of carrying one or more razor cartridges.

32. The shaving system of claim 31, wherein the first battery is carried by the dispenser.

33. The shaving system of claim 20, wherein the first battery is capable of contacting the second battery through an electrical contact.

34. The shaving system of claim 33, wherein the first battery is capable of electrically contacting the second battery through a hook and loop fastener.

35. The shaving system of claim 20, wherein the first battery is capable of charging the second battery without contacting the second battery.

36. The shaving system of claim 35, wherein the first battery is capable of inductively charging the second battery.

37. The shaving system of claim 20, wherein the shaving system is configured to interface with a mains power source to charge the second battery.

38. A shaving system, comprising:
a base;
a razor capable of mating with the base, the razor comprising a handle capable of engaging with a cartridge comprising a blade;
a secondary battery carried by the razor; and
a dispenser capable of mating with the base, the dispenser including one or more razor cartridges, and a primary battery capable of charging the secondary battery.

39. The shaving system of claim 38, wherein the secondary battery is an electrical power source selected from the group consisting of a nickel-cadmium battery and a nickel metal hydride battery.

40. The shaving system of claim 38, wherein the secondary battery has a nominal open cell voltage from about 1.2 to about 2.4 volts.

41. The shaving system of claim 38, wherein the secondary battery is in the handle.

42. The shaving system of claim 38, wherein the razor is electrically powered.

43. The shaving system of claim 42, wherein the razor is capable of vibrating.

44. The shaving system of claim 38 wherein the primary battery is an electrical power source selected from the group consisting of an alkaline battery, a metal-air battery, a lithium battery, metal oxyhydroxide battery, a fuel cell, and a photovoltaic cell.

45. The shaving system of claim 38, wherein the primary battery has a nominal open cell voltage greater than about 1.5 volt.

46. The shaving system of claim 38, wherein the primary battery is prismatic.

47. The shaving system of claim 38, wherein the primary battery is capable of contacting the secondary battery through an electrical contact.

48. The shaving system of claim 47, wherein the primary battery is capable of electrically contacting the secondary battery through a hook and loop fastener.

49. The shaving system of claim 38, wherein the primary battery is capable of charging the secondary battery without contacting the primary battery.

50. The shaving system of claim 49, wherein the primary battery is capable of inductively charging the secondary battery.

51. The shaving system of claim 38, wherein the shaving system is configured to engage with a mains power source to charge the secondary battery.

52. A wet shaving system, comprising:
a first electrical power source;
a razor; and
a second electrical power source in the razor,
wherein the first electrical power source is capable of charging the second electrical power source.

53. The shaving system of claim 52, wherein the power sources include batteries.

54. The shaving system of claim 52, wherein the second electrical source comprises a secondary battery, and the first electrical source comprises a primary battery.

55. The shaving system of claim 52, wherein the first electrical power source is selected from the group consisting of a fuel cell and a photovoltaic cell.

56. The shaving system of claim 52, wherein the first electrical power source is capable of contacting the second electrical power source through an electrical contact.

57. The shaving system of claim 52, wherein the first electrical power source is capable of charging the second electrical power source without contacting the second electrical power source.

58. The shaving system of claim 57, wherein the first electrical power source is capable of inductively charging the second electrical power source.

59. The shaving system of claim 52, wherein the shaving system is configured to engage with a mains power source to charge the second electrical power source.

60. A dispenser, comprising:
an electrical power source; and
at least one razor cartridge.

61. The dispenser of claim 60, comprising a plurality of razor cartridges.

62. The dispenser of claim 60, wherein the electrical power source comprises a battery.

63. The dispenser of claim 60, wherein the electrical power source comprises a primary battery.

64. The dispenser of claim 60, wherein the electrical power source comprises a plurality of batteries.

65. The dispenser of claim 60, wherein the dispenser is configured to be associated with a shaving system.

66. The dispenser of claim 65, wherein the dispenser is configured to mate with a base of the shaving system.
